(19) United States
(12) Patent Application Publication
(10) Pub. No.: US 2014/0004414 A1
(43) Pub. Date: Jan. 2, 2014

(54) NON-AQUEOUS ELECTROLYTE SECONDARY BATTERY AND METHOD FOR MANUFACTURING THE SAME

(71) Applicants: Atsushi SUGIHARA, Toyota-shi (JP); Takashi KONO, Okazaki-shi (JP); Tetsuya WASEDA, Okazaki-shi (JP); Masanori KITAYOSHI, Toyota-shi (JP); Tsubasa MATSUDA, Kariya-shi (JP); Shuji TSUTSUMI, Ikoma-shi (JP); Naoyuki WADA, Nagoya-shi (JP)

(72) Inventors: Atsushi SUGIHARA, Toyota-shi (JP); Takashi KONO, Okazaki-shi (JP); Tetsuya WASEDA, Okazaki-shi (JP); Masanori KITAYOSHI, Toyota-shi (JP); Tsubasa MATSUDA, Kariya-shi (JP); Shuji TSUTSUMI, Ikoma-shi (JP); Naoyuki WADA, Nagoya-shi (JP)

(73) Assignees: JTEKT CORPORATION, Osaka (JP); TOYOTA JIDOSHA KABUSHIKI KAISHA, Toyota-shi (JP)

(21) Appl. No.: 13/927,527

(22) Filed: Jun. 26, 2013

(30) Foreign Application Priority Data
Jun. 29, 2012 (JP) 2012-147902

(51) Int. Cl. H01M 4/133; H01M 4/04; H01M 4/1393

(52) U.S. Cl. CPC H01M 4/133; H01M 4/1393; H01M 4/0402; H01M 4/043
USPC 429/209; 427/58

(57) ABSTRACT

A non-aqueous electrolyte secondary battery includes a mixture layer of a negative electrode. The mixture layer contains carboxymethyl cellulose. A product of a median diameter (μm) of a negative electrode active material contained in the negative electrode and a ratio of a weight (wt %) of the carboxymethyl cellulose adsorbed on the negative electrode active material to a weight of the negative electrode active material is not less than 2.2 and not larger than 4.2.

### INCORPORATION BY REFERENCE

The disclosure of Japanese Patent Application No. 2012-147902 filed on Jun. 29, 2012 including the specification, drawings and abstract is incorporated herein by reference in its entirety.

### BACKGROUND OF THE INVENTION

1. Field of the Invention

The present invention relates to technologies of a non-aqueous electrolyte secondary battery and a method for manufacturing the same.

2. Description of Related Art

Non-aqueous electrolyte secondary batteries such as lithium ion secondary batteries used in hybrid automobiles are required to have high output characteristics and cycling characteristics. Conventionally, in order to improve output characteristics and cycling characteristics, various technologies are studied which specify physical properties of negative electrode active materials that form a negative electrode of a non-aqueous electrolyte secondary batteries in their raw material phase. For example, Japanese Patent Application Publication No. 2011-238622 (JP 2011-238622 A) described below discloses such a technology.

A related art disclosed in JP 2011-238622 A specifies the median diameter, tap density, specific surface, average circularity of graphite particles that are a material to form a negative electrode. Further, the related art specifies the crystal orientation ratio of graphite on an electrode plate under X-ray diffraction of the electrode plate made of the graphite particles. Moreover, it is disclosed that the related art disclosed in JP 2011-238622 A can provide a non-aqueous electrolyte secondary battery having high rapid charge and discharge characteristics and cycling characteristics.

However, although physical properties of a negative electrode active material are specified in its raw material phase as in the related art disclosed in JP 2011-238622 A, the physical properties variously change as the material undergoes each manufacturing step to a final product of a non-aqueous electrolyte secondary battery. Accordingly, the specification of physical properties of a negative electrode active material in its raw material phase may not ensure specification of characteristics of a non-aqueous electrolyte secondary battery as a final product.

In a non-aqueous electrolyte secondary battery, a negative electrode (more specifically, a mixture layer of a negative electrode) includes a negative electrode active material. There is a problem that excessively increasing the reaction area of the mixture layer results in a low initial resistance (in other words, the output characteristics are improved) but results in impaired durability (in other words, the cycling characteristics). On the other hand, excessively reducing the reaction area of the mixture layer results in a high initial resistance.

It has been known that the reaction area of the mixture layer of the negative electrode is determined by the specific surface of the negative electrode active material itself contained in the mixture layer and the adsorption amount of carboxymethyl cellulose (CMC) to the negative electrode active material (hereinafter referred to as CMC adsorption amount) and the specific surface becomes larger as the median diameter (also referred to as D50) in the particle size distribution of the negative electrode active material becomes smaller. Further, the reaction area of the mixture layer of the negative electrode becomes smaller as the CMC adsorption amount becomes larger.

In other words, when the median diameter and the CMC adsorption amount of the negative electrode active material in the mixture layer of the negative electrode are balanced to optimize the reaction area of the mixture layer in a non-aqueous electrolyte secondary battery, compatibility between the output characteristics and the cycling characteristics may be established.

### SUMMARY OF THE INVENTION

The present invention provides a non-aqueous electrolyte secondary battery and a method for manufacturing the same in which the median diameter and a carboxymethyl cellulose adsorption amount of the negative electrode active material in the mixture layer of the negative electrode are balanced and compatibility between output characteristics and cycling characteristics is established.

A first aspect of the present invention provides a non-aqueous electrolyte secondary battery containing carboxymethyl cellulose in a mixture layer of a negative electrode. In the non-aqueous electrolyte secondary battery, a product of a median diameter (μm) of a negative electrode active material contained in the negative electrode and a ratio of a weight (wt %) of the carboxymethyl cellulose adsorbed on the negative electrode active material to a weight of the negative electrode active material is not less than 2.2 and not larger than 4.2.

In the first aspect of the present invention, when a viscosity characteristic of the negative electrode active material exhibits a 70% torque of a maximum torque produced when linseed oil is titrated into a raw active material serving as a raw material of the negative electrode active material, an oil adsorption amount of linseed oil to the raw active material may be not lower than 50 ml and not higher than 60 ml per 100 g of the raw active material. Furthermore, the median diameter of the negative electrode active material may be not less than 8 μm and not larger than 13 μm.

In the first aspect of the present invention, at a press density of the negative electrode selected corresponding to a median diameter of the raw active material, the median diameter of the negative electrode active material may be set to the value not less than 8 μm and not larger than 13 μm.

A second aspect of the present invention includes: kneading a raw active material, carboxymethyl cellulose, and water to produce a primary kneaded body; diluting the primary kneaded body by adding water to produce a negative electrode paste; coating the negative electrode paste onto metal foil and drying the negative electrode paste; pressing the dried negative electrode paste to form a negative electrode; specifying an oil adsorption amount of linseed oil to the raw active material to not lower than 50 ml and not higher than 60 ml per 100 g of the raw active material in producing the primary kneaded body, wherein the oil adsorption amount is an amount at the time when a viscosity characteristic of the raw active material exhibits a 70% torque of a maximum torque produced when linseed oil is titrated into the raw active material; forming the negative electrode so that a median diameter of a negative electrode active material contained in the formed negative electrode is set to not smaller than 8 μm and not larger than 13 μm; and specifying a product of the median diameter (μm) of the negative electrode active material and a ratio of a weight (wt %) of the carboxymethyl cellulose adsorbed on a negative electrode active material to a weight of the negative electrode active material to a value not less than 2.2 and not larger than 4.2.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram illustrating a flow of a method for manufacturing a lithium ion secondary battery in accordance with an embodiment of the present invention;

FIG. 2 is a graph representing the relationship between D50×CMC adsorption amount and resistance and the relationship between D50×CMC adsorption amount and after-cycle capacity retention; and

FIG. 3 is a table showing experiment results of changes in characteristics of lithium ion secondary batteries according to change in D50×CMC adsorption amount.

### DETAILED DESCRIPTION OF EMBODIMENTS

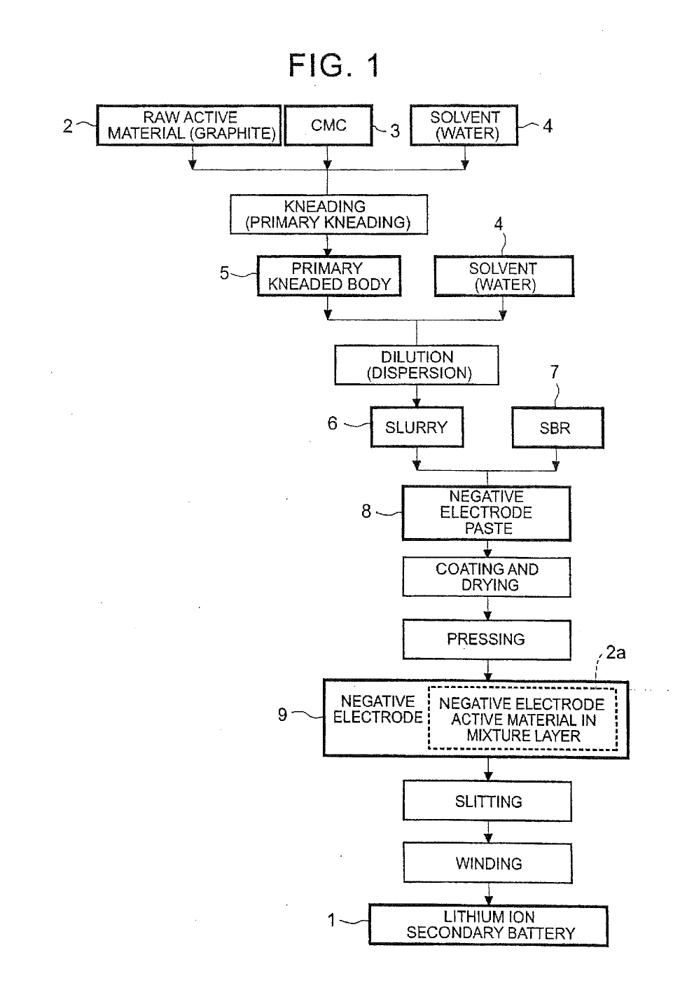

An embodiment of the present invention will next be described. A flow of a method for manufacturing a lithium ion secondary battery that is a non-aqueous electrolyte secondary battery in accordance with one embodiment of the present invention will first be described with reference to FIG. 1. As shown in FIG. 1, in a method for manufacturing a lithium ion secondary battery 1 that is the non-aqueous electrolyte secondary battery in accordance with one embodiment of the present invention, a negative electrode paste 8 for manufacturing a negative electrode 9 is produced. When the negative electrode paste 8 is produced, graphite 2 as a negative electrode active material, carboxymethyl cellulose (CMC) 3 as a thickener, water 4 as a solvent are mixed and kneaded. This kneading is a step also referred to as primary kneading. The primary kneading can be performed by use of a biaxial extrusion kneader, for example.

In the method for manufacturing the lithium ion secondary battery 1 in accordance with one embodiment of the present invention, the negative electrode active material in the state of raw material which is used in manufacturing the negative electrode 9 will be referred to as raw active material and will be distinguished from the negative electrode active material contained in the manufactured negative electrode 9. In one embodiment of the present invention, the graphite 2 with a median diameter (hereinafter denoted as D50) of 10.2 to 10.3 μm is used as the raw active material.

Further, in the method for manufacturing the lithium ion secondary battery 1 in accordance with one embodiment of the present invention, oil (linseed oil) is adsorbed on the graphite 2 used in the kneading. The amount of the oil to be adsorbed on the graphite 2 (hereinafter referred to as oil adsorption amount) is specified as described below. The “oil adsorption amount” described here is the oil adsorption amount on the graphite 2 at 70% torque generation when the maximum torque (100% torque), which is generated when linseed oil is titrated at a constant rate into the graphite 2 as the raw active material and the change in the viscosity characteristic is measured and recorded with a torque detector, is set as a reference. This torque may hereinafter be referred to simply as “70% torque”. Herein, this oil adsorption amount will be referred to as the oil adsorption amount at 70% torque. Further, herein, the oil adsorption amount at 70% torque may simply be referred to as “oil adsorption amount.”

Specifically, the oil adsorption amount of the raw active material (graphite 2) used in the method for manufacturing the lithium ion secondary battery in accordance with one embodiment of the present invention is set to a value not less than 50 ml/100 g and not more than 60 ml/100 g.

In the method for manufacturing the lithium ion secondary battery 1 in accordance with one embodiment of the present invention, the oil adsorption amount of the graphite 2 as the raw active material is specified, thereby adjusting the adsorption amount of CMC 3 to the graphite 2 (including a negative electrode active material 2a described later) (hereinafter referred to as CMC adsorption amount).

In this embodiment, the CMC adsorption amount is obtained by a method described below. A sample is diluted ten times with distilled water and centrifuged (for 30 minutes at 30,000 rpm), and a supernatant is collected. Then, the collected supernatant is further centrifuged (for 30 minutes at 30,000 rpm), and the resulting supernatant is collected. Next, a portion of the supernatant collected as described above is combusted. The CO₂ amount is measured by non-dispersive infrared gas analysis, thereby obtaining a total carbon amount A. Next, hydrochloric acid is added to the remaining supernatant, and the CO₂ is measured by non-dispersive infrared gas analysis, thereby obtaining the inorganic carbon amount B. The suspended CMC amount is calculated from the value of A-B. Further, the CMC adsorption amount (%) is calculated by dividing the value resulting from the subtraction of the suspended CMC amount from the added CMC amount by the added CMC amount and then multiplying the obtained value by 100.

In the method for manufacturing the lithium ion secondary battery 1 in accordance with one embodiment of the present invention, next, the solvent (water 4) is further added to a material produced by kneading (hereinafter referred to as primary kneaded body 5) to dilute the primary kneaded body 5, thereby producing a slurry 6 in which particles of the graphite 2 are dispersed in a medium formed of the solvent (water 4), the CMC 3, and so forth. Then, SBR 7 (binder) is added to the slurry 6 after dispersion, and a defoaming treatment and so forth are performed, thereby producing the negative electrode paste 8. The graphite 2, the CMC 3, the SBR 7 are solid components contained in the negative electrode paste 8.

In this embodiment, assuming that the total weight of the solid components is 100, the weight of the graphite 2 is 98.6, the weight of the CMC 3 is 0.7, and the weight of the SBR 7 is 0.7. In other words, in this embodiment, the negative electrode paste 8 is produced so that the weight percentage of the CMC 3 to the total weight of the solid components is 0.7.

Next, the negative electrode paste 8 produced in such conditions is coated onto copper foil, and steps of drying, pressing, slitting, and so forth are performed, thereby manufacturing the negative electrode 9 (negative electrode plate).

In the method for manufacturing the lithium ion secondary battery 1 in accordance with one embodiment of the present invention, press conditions are set so that the press density of the manufactured negative electrode 9 (more specifically the mixture layer of the negative electrode 9) is 1.13 g/cm³.

Further, in the method for manufacturing the lithium ion secondary battery 1 in accordance with one embodiment of the present invention, manufacturing conditions are adjusted as described above, thereby setting the D50 of the graphite 2 contained in the mixture layer of the manufactured negative electrode 9 to a value not less than 8 μm and not larger than 13 μm. Hereinafter, the graphite 2 contained in the mixture layer of the manufactured negative electrode 9 is called as negative electrode active material 2a.

Moreover, in the method for manufacturing the lithium ion secondary battery 1 in accordance with one embodiment of the present invention, the above-mentioned conditions are specified, thereby setting, to the weight of the negative electrode active material 2a (in other words, the CMC adsorption amount), the product of the D50 value of the negative electrode active material 2a and the value of the ratio of the weight of the CMC 3 adsorbed on the negative electrode active material 2a to a value not less than 2.2 and not larger than 42. Here, the unit of the D50 of the negative electrode active material 2a is μm, and the unit of the CMC adsorption amount is weight percent (also denoted as wt %).

Further, in the method for manufacturing the lithium ion secondary battery in accordance with one embodiment of the present invention, the negative electrode 9 manufactured as described above is wound together with a positive electrode (not shown) and a separator (not shown) to produce a wound body (not shown). The wound body is housed in a casing (not shown), an electrolytic solution (not shown) is poured thereinto, and the casing is sealed, thereby manufacturing the lithium ion secondary battery 1 having a capacity of 4 Ah.

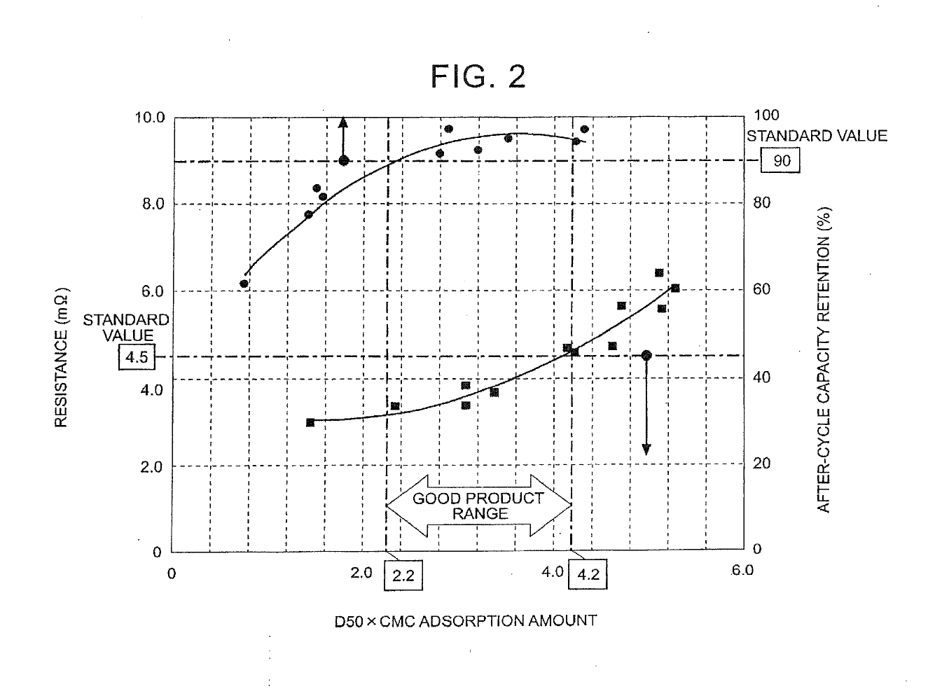

Next, the characteristics of the lithium ion secondary battery 1 manufactured by the method for manufacturing the lithium ion secondary battery in accordance with one embodiment of the present invention will be described with reference to FIG. 2. FIG. 2 represents the relationship between the resistance of the lithium ion secondary battery 1 and the product of the D50 of the negative electrode active material 2a of the lithium ion secondary battery 1 and the CMC adsorption amount to the negative electrode active material 2a (hereinafter referred to simply as D50×CMC adsorption amount) and the relationship between the after-cycle capacity retention of the lithium ion secondary battery 1 and the D50×CMC adsorption amount.

According to FIG. 2, the lower limit value (in other words, 2.2) in the specified value of the D50×CMC adsorption amount is specified with a standard value of the resistance as a reference. Further; the upper limit value (in other words, 4.2) in the specified value of the D50×CMC adsorption amount is specified with a standard value of the after-cycle capacity retention as a reference. Accordingly, the D50×CMC adsorption amount that falls in the range of 2.2 to 4.2 satisfies the standard value of the resistance (not higher than 4.5 mΩ) of the lithium ion battery 1 and satisfies the standard value of the after-cycle capacity retention (not lower than 90%) of the lithium ion secondary battery 1.

Further, as shown in FIG. 2, it is understood that the range in which the D50×CMC adsorption amount value falls in 2.2 to 4.2 is specified as a good product range and the negative electrode 9 is manufactured so that the D50×CMC adsorption amount value falls in the good product range, thereby allowing compatibility between the output characteristics and the cycling characteristics in the lithium ion secondary battery 1.

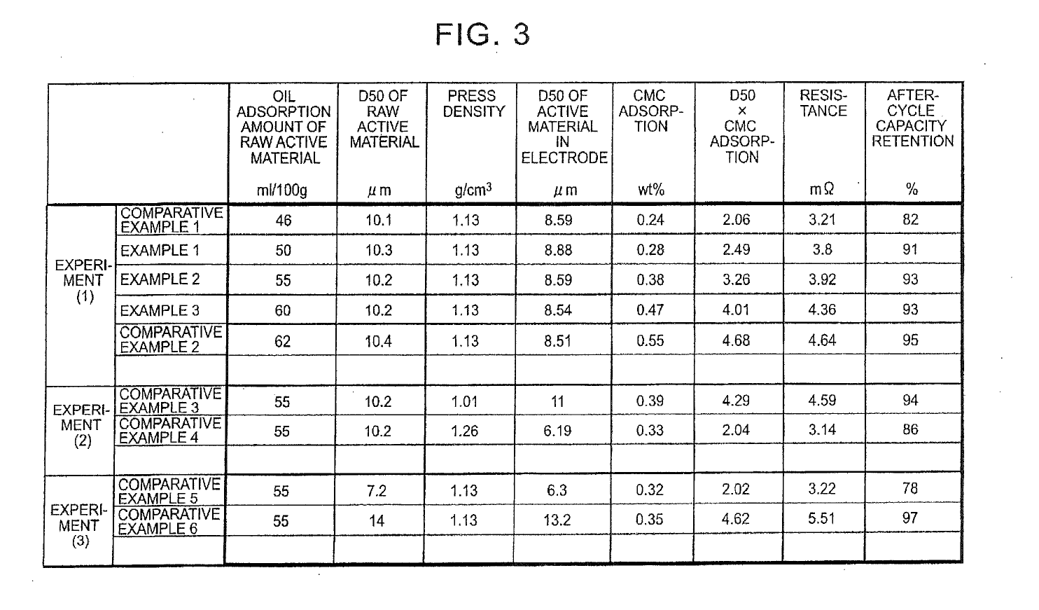

The characteristics of the lithium ion secondary battery 1 manufactured by the method for manufacturing the non-aqueous electrolyte secondary battery in accordance with one embodiment of the present invention will more specifically be described with reference to FIGS. 1 and 3. FIG. 3 shows experiment results of experiments (1), (2), and (3) described below.

In experiment (1), the change in performance of the lithium ion secondary battery 1 was examined in the case that the D50 of the raw active material (graphite 2) and the press density of the negative electrode 9 (mixture layer) were set substantially constant and the oil adsorption amount of the raw active material (graphite 2) was varied. Here, resistance and after-cycle capacity retention were selected as the indices representing the change in performance of the lithium ion secondary battery. It can be understood that resistance reflects the quality of the output characteristics and a lower resistance corresponds to higher output characteristics. It can be understood that after-cycle capacity retention reflects the quality of the cycling characteristics and higher after-cycle capacity retention corresponds to higher cycling characteristics.

In experiment (2), the change in performance of the lithium ion secondary battery 1 was examined in the case that the oil adsorption amount of the raw active material (graphite 2) and the D50 of the raw active material (graphite 2) were set substantially constant and the press density of the negative electrode 9 was varied. In experiment (3), the change in performance of the lithium ion secondary battery 1 was examined in the case that the oil adsorption amount of the raw active material (graphite 2) and the press density of the negative electrode 9 were set substantially constant and the D50 of the raw active material (graphite 2) was varied.

The resistances in experiments (1) to (3) were calculated from the voltage drop amount in electric discharge for ten seconds in a condition of 25° C., 3.7 V, and 20 A.

The after-cycle capacity retentions in experiments (1) to (3) were calculated from the ratio between the capacities before and after the cycles in the case where 1000 cycles of electric charge and discharge were performed in a condition of −10° C., 3.0 to 4.1 V, and 4 A.

The experiment results of experiment (1) will first be discussed. In experiment (1), the change in performance of the lithium ion secondary battery was examined in the case that the D50 of the raw active material (graphite 2) and the press density of the negative electrode 9 were set substantially constant and the oil adsorption amount of the raw active material (graphite 2) was varied.

Lithium ion secondary batteries represented by examples 1 to 3 shown in FIG. 3 were the lithium ion secondary batteries 1 in accordance with one embodiment of the present invention. In other words, the lithium ion secondary batteries represented by examples 1 to 3 satisfied the specified value of the oil adsorption amount (not lower than 50 ml/100 g and not higher than 60 ml/100 g) of the graphite 2. Accordingly, the lithium ion secondary batteries represented by examples 1 to 3 satisfied the specified value of the D50 (not less than 8 μm and not larger than 13 μm) of the negative electrode active material 2a and further satisfy the specified value of the D50×CMC adsorption amount (not less than 2.2 and not larger than 4.2) of the negative electrode active material 2a.

On the other hand, lithium ion secondary batteries corresponding to comparative examples 1 and 2 shown in FIG. 3 had the oil adsorption amounts (graphite 2) of the negative electrode active material that fell out of the specified value. Accordingly, the lithium ion secondary batteries corresponding to comparative examples 1 and 2 did not satisfy the specified value of the D50×CMC adsorption amount (not less than 2.2 and not larger than 4.2) of the negative electrode active material 2a and thus did not correspond to the lithium ion secondary battery 1 in accordance with one embodiment of the present invention. The lithium ion secondary batteries corresponding to comparative examples 1 and 2 satisfied the specified value of the D50 (not less than 8 μm and not larger than 13 μm) of the negative electrode active material 2a.

Further, the lithium ion secondary batteries 1 represented by examples 1 to 3 have resistances of 3.8 to 4.36 mΩ and thus satisfied the standard value (not higher than 4.5 mΩ) of resistance. Moreover, the lithium ion secondary batteries 1 represented by examples 1 to 3 had after-cycle capacity retentions of 91% to 93% and thus satisfied the standard value of after-cycle capacity retention (not lower than 90%).

On the other hand, the lithium ion secondary battery represented by comparative example 1 had a resistance of 3.21 mΩ and satisfied the standard value of resistance (not higher than 4.5 mΩ). However, since the after-cycle capacity retention was 82%, the battery did not satisfy the standard value of after-cycle capacity retention (not lower than 90%). According to the results of comparative example 1, it is considered that since the adsorption amount of the CMC 3 to the graphite 2 became low when the oil adsorption amount of the raw active material (graphite 2) was low, the peel strength of the mixture layer in the negative electrode 9 decreased, and Li deposited during the cycles, thus resulting in a decrease in the after-cycle capacity retention.

Further, the lithium ion secondary battery represented by comparative example 2 had an after-cycle capacity retention of 95% and satisfied the standard value of after-cycle capacity retention (not lower than 90%). However, since the resistance was 4.64 mΩ, the battery did not satisfy the standard value of resistance (not higher than 4.5 mΩ). According to the results of comparative example 2, it is considered that since the adsorption amount of the CMC to the graphite 2 was large when the oil adsorption amount to the graphite 2 as the raw active material was high, the reaction area of the mixture layer of the negative electrode 9 decreased, thereby resulting in an increase in the resistance.

In other words, from the results of experiment (1), it was observed that setting the specified value of the D50×CMC adsorption amount of the negative electrode active material 2a to a value not less than 2.2 and not larger than 4.2 allowed compatibility between the output characteristics and the cycling characteristics. More specifically, the oil adsorption amount of the graphite 2 is preferably set to a value not lower than 50 ml/100 g and not higher than 60 ml/100 g, and the D50 of the negative electrode active material 2a of the negative electrode 9 is preferably set to value not less than 8 μm and not larger than 13 μm.

As described above, the non-aqueous electrolyte secondary battery in accordance with one embodiment of the present invention is the lithium ion secondary battery 1. The lithium ion secondary battery 1 contains the CMC 3 in the mixture layer of the negative electrode 9. Further, the product of the D50 (μm) of the negative electrode active material 2a present in the negative electrode 9 and the ratio (%) of the weight of the CMC 3 adsorbed on the negative electrode active material 2a to the weight of the negative electrode active material 2a is specified to a value not less than 2.2 and not larger than 4.2. The method for manufacturing the lithium ion secondary battery 1 that is the non-aqueous electrolyte secondary battery in accordance with one embodiment of the present invention includes at least the steps of kneading the graphite 2 as the raw active material, the CMC 3, and the water 4 to produce the primary kneaded body 5; diluting the primary kneaded body 5 by adding the water 4 to produce the negative electrode paste 8 for manufacturing the negative electrode 9; coating the negative electrode paste 8 onto metal foil and drying the negative electrode paste; and pressing the dried negative electrode paste 8 to form the negative electrode 9. The oil adsorption amount of linseed oil to the graphite 2 at 70% torque in the step of producing the primary kneaded body 5 is specified to a value not lower than 50 ml and not higher than 60 ml per 100 g of the graphite. Further, the negative electrode 9 is formed so that the D50 of the negative electrode active material 2a as the graphite 2 present in the negative electrode 9 is not less than 8 μm and not larger than 13 μm. The product of the D50 (μm) of the negative electrode active material 2a and the ratio (%) of the weight of the CMC 3 adsorbed on the negative electrode active material 2a to the weight of the negative electrode active material 2a is specified to not less than 2.2 and not larger than 4.2. Such a configuration enables provision of the lithium ion secondary battery 1 that is the non-aqueous electrolyte secondary battery allowing compatibility between the output characteristics and the cycling characteristics.

Further, in the lithium ion secondary battery 1 that is the non-aqueous electrolyte secondary battery in accordance with one embodiment of the present invention, the oil adsorption amount of linseed oil to the graphite 2 as the raw active material at 70% torque is specified to a value not lower than 50 nil and not higher than 60 ml per 100 g of the graphite. Moreover, the D50 of the negative electrode active material 2a is specified to a value not less than 8 μm and not larger than 13 μm. According to such a configuration, the product of the D50 (μm) of the negative electrode active material 2a of the negative electrode 9 and the ratio (%) of the weight of the CMC 3 adsorbed on the negative electrode active material 2a to the weight of the negative electrode active material 2a is specified to a value not less than 2.2 and not larger than 4.2.

The experiment results of experiment (2) will next be discussed. In experiment (2), the lithium ion secondary battery 1 of example 2 in experiment (1) was used as a reference, and the change in performance of the lithium ion secondary battery was examined in the case that the oil adsorption amount of the raw active material (graphite 2) and the D50 of the raw active material (graphite 2) were set substantially constant and the press density of the negative electrode 9 was varied.

More specifically, the D50 of the graphite 2 as the raw active material selected in experiment (2) was the same as the D50 (10.2 μm) of the graphite 2 of example 2 in experiment (1). On the other hand, comparative examples 3 and 4 had the negative electrodes 9 pressed at different press densities. In comparative example 3, the press density was low compared to example 2. In comparative example 4, the press density was high compared to example 2.

A lithium ion secondary battery corresponding to comparative example 3 shown in FIG. 3 satisfied the specified value of the oil adsorption amount (not lower than 50 ml/100 g and not higher than 60 ml/100 g) of the negative electrode active material (graphite 2).

However, the lithium ion secondary battery represented by comparative example 3 did not satisfy the specified value of the D50×CMC adsorption amount (not less than 2.2 and not larger than 4.2) of the negative electrode active material 2a.

The lithium ion secondary battery represented by comparative example 3 had after-cycle capacity retentions of 94% and thus satisfied the standard value (not lower than 90%) of after-cycle capacity retention. On the other hand, the battery had a resistance of 4.59 ma and thus did not satisfy the standard value of resistance (not higher than 4.5 mΩ). It is considered that since the negative electrode active material 2a was not sufficiently pressed due to a low press density, the reaction area of the negative electrode active material 2a of the negative electrode 9 became small and the resistance thus became high.

Further, a lithium ion secondary battery corresponding to comparative example 4 shown in FIG. 3 satisfied the specified value of the oil adsorption amount (not lower than 50 ml/100 g and not higher than 60 ml/100 g) of the negative electrode active material (graphite 2) but did not satisfy the specified value of the D50 (not less than 8 μm and not larger than 13 μm) of the negative electrode active material 2a.

Moreover, the lithium ion secondary battery represented by comparative example 4, as a result of forming the negative electrode 9 in the above condition, did not satisfy the specified value of the D50×CMC adsorption amount (not less than 2.2 and not larger than 4.2) of the negative electrode active material 2a.

Further, the lithium ion secondary battery represented by comparative example 4 had a resistance of 3.14 mΩ and satisfied the standard value of resistance (not higher than 4.5 mΩ). However, since the after-cycle capacity retention was S6%, the battery did not satisfy the standard value of the after-cycle capacity retention (not lower than 90%). It is considered that since the negative electrode active material 2a was excessively pressed due to a high press density of the negative electrode 9, the reaction area of the negative electrode active material 2a became large and the after-cycle capacity retention thus became low.

In other words, from the results of experiment (2), it was observed that even though the graphite 2 as the raw active material was appropriately selected and the oil adsorption amount to the graphite 2 was also appropriate, if the press pressure in the subsequent press was not appropriately set and the D50 of the negative electrode active material 2a of an electrode 9 fell out of the specified value, the D50×CMC adsorption amount also fell out of the standard value, thus not allowing compatibility between the output characteristics and the cycling characteristics. Further, from the results of experiment (2), it is understood that in order to obtain compatibility between the output characteristics and the cycling characteristics in the non-aqueous electrolyte secondary battery, the press condition in forming the negative electrode 9 is required to be appropriately set.

The experiment results of experiment (3) will next be discussed. In experiment (3), the lithium ion secondary battery 1 of example 2 in experiment (1) was used as a reference, and the change in performance of the lithium ion secondary battery was examined in the case that the oil adsorption amount of the raw active material (graphite 2) and the press density of the negative electrode 9 were set substantially constant and the D50 of the raw active material (graphite 2) was varied.

More specifically, the press density (1.13 g/cm³) for producing the negative electrode 9 in experiment (3) was the same as that in the case of example 2 in experiment (1). However, the D50 of the selected raw active material (graphite 2) was different. In comparative example 5, the D50 of the graphite 2 was small compared to example 2. In comparative example 6, the D50 of the graphite 2 was large compared to example 2.

Further, a lithium ion secondary battery corresponding to comparative example 5 shown in FIG. 3 satisfied the specified value of the oil adsorption amount (not lower than 50 ml/100 g and not higher than 60 ml/100 g) of the negative electrode active material (graphite 2) but did not satisfy the specified value of the D50 (not less than 8 μm and not larger than 13 μm) of the negative electrode active material 2a.

Moreover, the lithium ion secondary battery represented by comparative example 5, as a result of forming the negative electrode mixture layer in the above condition, did not satisfy the specified value of the D50×CMC adsorption amount (not less than 2.2 and not larger than 4.2) of the negative electrode active material 2a.

Further, the lithium ion secondary battery represented by comparative example 5 had a resistance of 3.22 mΩ and satisfied the standard value of resistance (not higher than 4.5 mΩ). However, since the after-cycle capacity retention was 78%, the battery did not satisfy the standard value of the after-cycle capacity retention (not lower than 90%). It is considered that the D50 of the negative electrode active material 2a became small due to the small D50 of the graphite 2 as the raw active material, and this resulted in a larger reaction area and a proper resistance, but the after-cycle capacity retention was impaired.

On the other hand, a lithium ion secondary battery corresponding to comparative example 6 shown in FIG. 3 satisfied the specified value of the oil adsorption amount (not lower than 50 ml/100 g and not higher than 60 ml/100 g) of the negative electrode active material (graphite 2) but did not satisfy the specified value of the D50 (not less than 8 μm and not larger than 13 μm) of the negative electrode active material 2a.

Further, the lithium ion secondary battery represented by comparative example 6, as a result of forming the negative electrode mixture layer in the above condition, did not satisfy the specified value of the D50×CMC adsorption amount (not less than 2.2 and not larger than 4.2) of the negative electrode active material 2a.

Moreover, the lithium ion secondary battery represented by comparative example 6 had an after-cycle capacity retention of 97% and satisfied the standard values of after-cycle capacity retention (not lower than 90%). However, since the resistance was 5.51 mΩ, the battery did not satisfy the standard values of resistance (not higher than 4.5 mΩ). It is considered that the D50 of the negative electrode active material 2a became large due to the large D50 of the graphite 2 as the raw active material, and this resulted in a smaller reaction area and a proper after-cycle capacity retention, but the initial resistance was impaired.

In other words, from the results of experiment (3), it was observed that even though the graphite 2 as the oil adsorption amount to the graphite 2 as the raw active material was appropriate and the press pressure in manufacturing the negative electrode 9 was appropriately set, if the graphite 2 as the raw active material was not appropriately selected and the D50 of the negative electrode active material 2a of a negative electrode 9 fell out of the specified value, the D50×CMC adsorption amount also fell out of the standard value, thus not allowing compatibility between the output characteristics and the cycling characteristics. Further, from the results of experiment (3), it is understood that in order to obtain compatibility between the output characteristics and the cycling characteristics in the non-aqueous electrolyte secondary battery, the D50 of the graphite 2 as the raw active material for forming the negative electrode 9 is required to be appropriately selected.

As described above, in the lithium ion secondary battery 1 that is the non-aqueous electrolyte secondary battery in accordance with one embodiment of the present invention, the press density of the negative electrode 9 corresponding to the D50 of the graphite 2 as the raw active material is selected, and the D50 of the negative electrode active material 2a is specified to a value not less than 8 μm and not larger than 13 μm. Such a configuration allows the D50 (μm) of the negative electrode active material 2a of the negative electrode 9 to fall in a value not less than 8 μm and not larger than 13 μm.

An embodiment of the present invention enables provision of a non-aqueous electrolyte secondary battery allowing compatibility between the output characteristics and the cycling characteristics.

What is claimed is:

1. A non-aqueous electrolyte secondary battery comprising
a mixture layer of a negative electrode, the mixture layer containing carboxymethyl cellulose,
wherein a product of a median diameter (μm) of a negative electrode active material contained in the negative electrode and a ratio of a weight (wt %) of the carboxymethyl cellulose adsorbed on the negative electrode active material to a weight of the negative electrode active material is not less than 2.2 and not larger than 4.2.

2. The non-aqueous electrolyte secondary battery according to claim 1,
wherein when a viscosity characteristic of the negative electrode active material exhibits a 70% torque of a maximum torque produced when linseed oil is titrated into a raw active material serving as a raw material of the negative electrode active material, an oil adsorption amount of linseed oil to the raw active material is not lower than 50 ml and not higher than 60 ml per 100 g of the raw active material, and
the median diameter of the negative electrode active material is not less than 8 μm and not larger than 13 μm.

3. The non-aqueous electrolyte secondary battery according to claim 2,
wherein at a press density of the negative electrode selected corresponding to a median diameter of the raw active material, the median diameter of the negative electrode active material is set to the value not less than 8 μm and not larger than 13 μm.

4. A method for manufacturing a non-aqueous electrolyte secondary battery, the method comprising:
kneading a raw active material, carboxymethyl cellulose, and water to produce a primary kneaded body;
diluting the primary kneaded body by adding water to produce a negative electrode paste;
coating the negative electrode paste onto metal foil and drying the negative electrode paste;
pressing the dried negative electrode paste to form a negative electrode;
specifying an oil adsorption amount of linseed oil to the raw active material to not lower than 50 ml and not higher than 60 ml per 100 g of the raw active material in producing the primary kneaded body, wherein the oil adsorption amount is an amount at the time when a viscosity characteristic of the raw active material exhibits a 70% torque of a maximum torque produced when linseed oil is titrated into the raw active material;
forming the negative electrode so that a median diameter of a negative electrode active material contained in the formed negative electrode is set to not smaller than 8 μm and not larger than 13 μm; and
specifying a product of the median diameter (μm) of the negative electrode active material and a ratio of a weight (wt %) of the carboxymethyl cellulose adsorbed on a negative electrode active material to a weight of the negative electrode active material to a value not less than 2.2 and not larger than 4.2.
